(19) United States
(12) Patent Application Publication
(10) Pub. No.: US 2022/0257060 A1
(43) Pub. Date: Aug. 18, 2022

(54) COOKING UTENSIL COMPATIBLE WITH A ROBOT END EFFECTOR

(71) Applicant: Nala Robotics, Inc., Arlington Heights, IL (US)

(72) Inventors: Vijay Kodali, Palatine, IL (US); Ajay Kumar Sunkara, South Barrington, IL (US)

(21) Appl. No.: 17/591,922

(22) Filed: Feb. 3, 2022

Related U.S. Application Data
(60) Provisional application No. 63/149,772, filed on Feb. 16, 2021.

(51) Int. Cl. A47J 44/00; B25J 11/00; B25J 15/08; A47J 43/28; A47J 45/06

(52) U.S. Cl. CPC A47J 44/00; B25J 11/0045; A47J 45/063; A47J 43/281; B25J 15/08

(57) ABSTRACT

A cooking system including an end effector and a cooking utensil configured for being maneuvered about a kitchen station through the end effector, the cooking utensil including a body and a grip. The body is configured for maneuvering food items. The grip is fixed with the body and extended from the body in a longitudinal direction of the cooking utensil. The grip includes a grip body, a knob disposed on a proximal end of the grip body, and a stop disposed on a distal end of the grip body such that the grip body is interposed between and separates the knob and the stop in the longitudinal direction of the cooking utensil. The knob and the stop extend beyond the grip body in a first lateral direction of the cooking utensil perpendicular to the longitudinal direction of the cooking utensil.

### BACKGROUND

Automated cooking systems can be advantageous over conventional human-driven cooking for reducing an amount of human effort expended in preparing a meal, and for improving aspects of reliability, consistency, quality, and safety in prepared meals beyond reasonable human abilities. Robot arms employed in automated cooking systems with industry standard grippers, however, often face difficulty in establishing a functional grip on, and manipulating cooking hardware and utensils originally designed for human use. Consequently, there is demand for cooking hardware and utensils compatible with robot arms in automated cooking systems.

### BRIEF DESCRIPTION

According to one aspect, a cooking system including an end effector and a cooking utensil configured for being maneuvered about a kitchen station through the end effector, the cooking utensil including a body and a grip. The body is configured for maneuvering food items. The grip is fixed with the body and extended from the body in a longitudinal direction of the cooking utensil. The grip includes a grip body, a knob disposed on a proximal end of the grip body, and a stop disposed on a distal end of the grip body such that the grip body is interposed between and separates the knob and the stop in the longitudinal direction of the cooking utensil. The knob and the stop extend beyond the grip body in a first lateral direction of the cooking utensil perpendicular to the longitudinal direction of the cooking utensil, and the knob forms a first inclined surface that is inclined outward from the grip body in the first lateral direction of the cooking utensil, and away from the stop in the longitudinal direction of the cooking utensil. The end effector includes a hand, and a first finger mounted on the hand, and configured for being actuated with respect to the hand and engaging the grip in the first lateral direction of the cooking utensil. The first finger includes a first inclined surface configured for engaging and extending along the first inclined surface of the knob in the longitudinal direction and the first lateral direction of the cooking utensil, and a first longitudinal end surface extended from the first inclined surface of the first finger in the longitudinal direction of the cooking utensil, and configured for extending along the grip body and engaging the stop in the longitudinal direction of the cooking utensil.

A method of engaging an end effector with a cooking utensil, the method including fixing a grip with a body included in the cooking utensil and configured for maneuvering food items such that the grip extends from the body in a longitudinal direction of the cooking utensil, where the grip includes a grip body, a knob disposed on a proximal end of the grip body, and a stop disposed on a distal end of the grip body such that the grip body is interposed between and separates the knob and the stop in the longitudinal direction of the cooking utensil, the knob and the stop extending beyond the grip body in a first lateral direction of the cooking utensil perpendicular to the longitudinal direction of the cooking utensil. The method also includes mounting a first finger on a hand included in the end effector such that the first finger is configured for being actuated with respect to the hand in a first lateral direction of the cooking utensil perpendicular to the longitudinal direction of the cooking utensil. The method also includes actuating the first finger with respect to the hand in the first lateral direction of the cooking utensil to engage the first finger with the grip in the first lateral direction of the cooking utensil, where a first inclined surface of the first finger that is inclined toward the grip body in the first lateral direction of the cooking utensil, and toward the stop in the longitudinal direction of the cooking utensil, engages the knob in the longitudinal direction and the first lateral direction of the cooking utensil, and where a first longitudinal end surface of the first finger that extends from the first inclined surface of the first finger and toward the stop in the longitudinal direction of the cooking utensil engages the grip between the knob and the stop in the longitudinal direction of the cooking utensil.

### BRIEF DESCRIPTION OF THE DRAWINGS

FIG. 1 depicts a perspective view of a robot arm holding a cooking utensil in the form of a spatula at a kitchen station.

FIG. 2 depicts a perspective view of the spatula.

FIG. 3 depicts a partial perspective view of the robot arm holding the spatula.

FIG. 4 depicts a partial perspective view of the robot arm holding the spatula.

FIG. 4A depicts a partial front view of the robot arm and an end effector in a position configured for holding the spatula.

FIG. 5 depicts a side view of the robot arm holding the spatula.

FIG. 6 depicts a top view of the robot arm holding the spatula.

FIG. 7 depicts a perspective view of the robot arm at the kitchen station.

FIG. 8 depicts a perspective view of the robot arm at the kitchen station.

FIG. 9 depicts a side view of the robot arm at the kitchen station.

FIG. 10 depicts a partial perspective view of the robot arm at the kitchen station including the spatula.

FIG. 11 depicts a perspective view of the kitchen station with the spatula.

FIG. 12 depicts a partial perspective view of the robot arm including an end effector.

FIG. 13 depicts a perspective view of the robot arm.

FIG. 14 depicts a perspective view of the robot arm holding a cup.

FIG. 15 depicts a perspective view of the robot arm holding the cup at the kitchen station.

FIG. 16 depicts a side view of the robot arm holding the cup at the kitchen station.

FIG. 17 depicts a partial bottom perspective view of the robot arm holding the cup.

### DETAILED DESCRIPTION

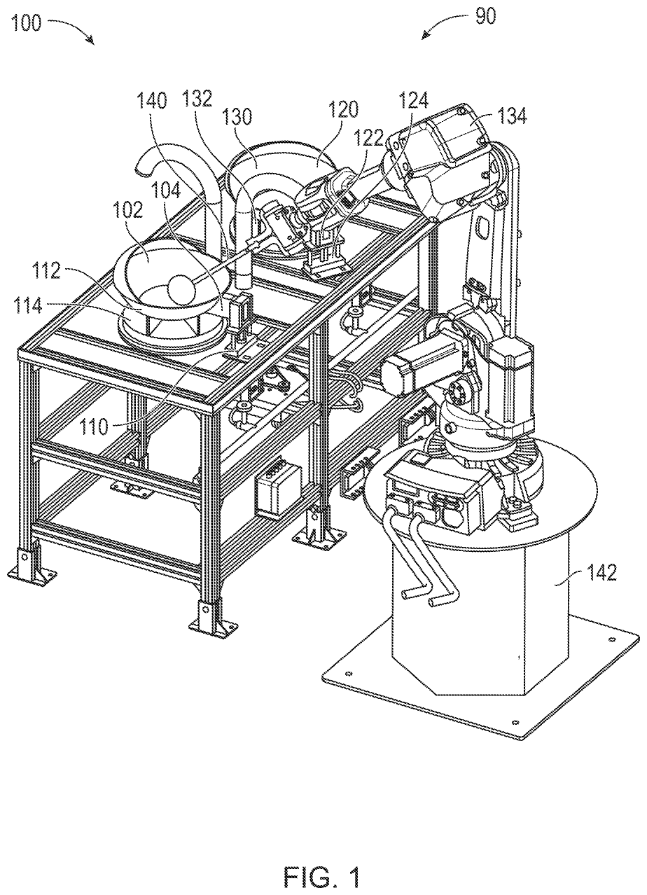

It should, of course, be understood that the description and drawings herein are merely illustrative and that various modifications and changes can be made in the structures disclosed without departing from the present disclosure. Referring now to the drawings, wherein like numerals refer to like parts throughout the several views, FIG. 1 depicts a cooking system 90 having a kitchen station 100 that includes a first pan 102 with a first handle 104 supported on a first pan mount 110 and a first body 112 supported on a first stove 114. The kitchen station 100 also includes a second pan 120 with a second handle 122 supported on a second pan mount 124 and a second body 130 supported on a second stove 132. The second pan 120, the second pan mount 124, and the second stove 132 respectively feature a construction similar to the first pan 102, the first pan mount 110, and the first stove 114. Unless otherwise stated, the following description made with reference to the first pan 102, the first pan mount 110, and the first stove 114 is similarly applicable to the second pan 120, the second pan mount 124, and the second stove 132.

As shown in FIG. 1, the cooking system 90 includes a robot arm 134 at the kitchen station 100 configured for maneuvering a cooking utensil in the form of a spatula 140 in an interior of the first pan 102 defined by the first body 112. The first body 112 is configured for holding food items (not shown) over the first stove 114 for cooking the food items, and in this regard the robot arm 134 is configured for maneuvering the food items about the interior of the first pan 102 while the food items are being cooked over the first stove 114. The robot arm 134 is supported by, and fixed on a base 142 at the kitchen station 100 within a reaching range of the robot arm 134 with the spatula 140 such that the robot arm 134 is capable of reaching the interior of the first pan 102 with the spatula 140 to maneuver the food items in the interior of the first pan 102, and is capable of reaching an interior of the second pan 120 defined by the second body 130 with the spatula 140 to maneuver food items (not shown) in the interior of the second pan 120.

While the depicted kitchen station 100 includes a first stove 114 and a second stove 132, any number of stoves similar to the first stove 114 and the second stove 132, and any number of corresponding pans similar to the first pan 102 and the second pan 120 can be incorporated into the kitchen station 100 without departing from the scope of the present disclosure, where the robot arm 134 with the spatula 140 is otherwise configured to access an interior of each pan at each stove of the kitchen station 100 for maneuvering food contents therein. In an embodiment, the base 142 is mobilized and configured to transport the robot arm 134 to multiple stoves across the kitchen station 100.

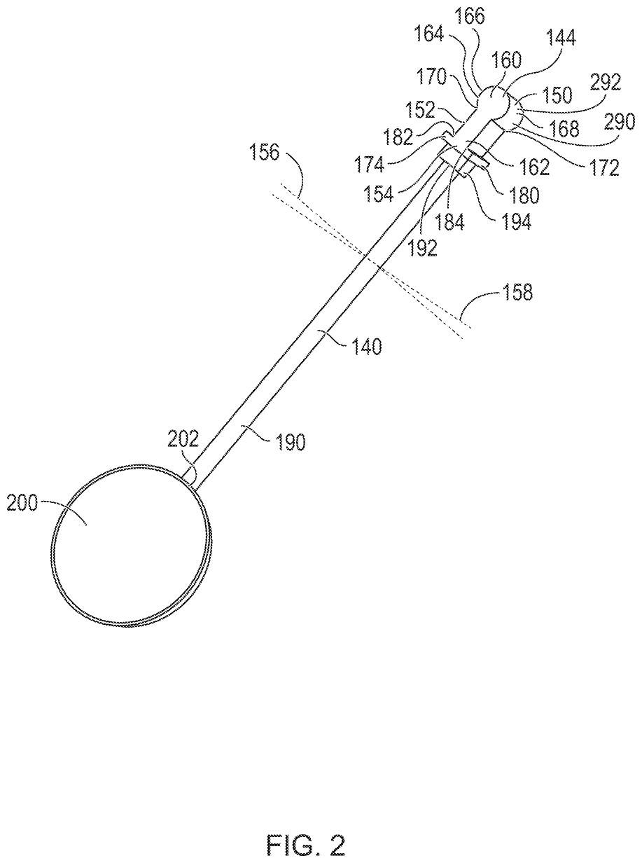

FIG. 2 depicts a perspective view of the spatula 140. The spatula 140 includes a grip 144 having a knob 150, a grip body 152, and a stop 154. The knob 150 is disposed on a proximal end 160 of the grip body 152 and the stop 154 is disposed on a distal end 162 of the grip body 152 such that the grip body 152 is interposed between and separates the knob 150 and the stop 154 on the grip 144 along a longitudinal direction of the spatula 140.

The knob 150 has a cylindrical shape with a circular face extended in the longitudinal direction of the spatula and a first lateral direction 156 of the spatula 140 perpendicular to the longitudinal direction of the spatula 140, and a body extended in a second lateral direction 158 of the spatula 140 perpendicular to the longitudinal direction and the first lateral direction 156 of the spatula 140. The cylindrical shape of the knob 150 defines a first inclined surface 164 and a second inclined surface 166 formed on opposite sides of the knob 150 in the longitudinal direction of the spatula 140. In this manner, the first inclined surface 164 and the second inclined surface 166 of the knob 150 are rounded toward the grip body 152 in the first lateral direction 156 of the spatula 140. The first inclined surface 164 and the second inclined surface 166 of the knob 150 extend continuously with each other in the longitudinal direction of the spatula 140.

The first inclined surface 164 is inclined outward from the grip body 152 in the first lateral direction 156 of the spatula 140, and away from the stop 154 in the longitudinal direction of the spatula 140. The second inclined surface 166 is inclined toward the grip body 152 in the first lateral direction 156 of the spatula 140, and away from the stop 154 in the longitudinal direction of the spatula 140.

In the depicted aspect, the grip body 152 has a rectangular prism shape extended with the knob 150 in the second lateral direction 158 of the spatula 140. The knob 150, the grip body 152, and the stop 154 form a lateral surface 168 of the grip 144 facing the first lateral direction 156 of the spatula 140, and extending straight in the second lateral direction 158 of the spatula 140. The circular shape of the knob 150 extends in the first lateral direction 156 of the spatula 140 beyond the rectangular prism shape of the grip body 152 such that the knob 150 and the grip body 152 form a first knob incongruity 170 and a third knob incongruity 172 on the lateral surface 168. The grip body 152 extends in the longitudinal direction of the spatula 140 to the knob 150, forming the first knob incongruity 170 in the grip 144 directly between the first inclined surface 164 of the knob 150 on one side of the grip body 152, and forming the third knob incongruity 172 in the grip 144 directly between the knob 150 on an opposite side of the grip body 152.

The stop 154 includes a first flange 174 and a second flange 180 extended in the first lateral direction 156 of the spatula 140, extended from opposite sides of the grip 144 at the distal end 162 of the grip body 152, and extended in opposite directions as each other in the first lateral direction 156 of the spatula 140. The first flange 174 and the second flange 180 respectively extend beyond the grip body 152 in the first lateral direction 156 of the spatula 140, and extend along the second lateral direction 158 of the spatula 140 to form a second knob incongruity 182 and a fourth knob incongruity 184 with the grip body 152 along the lateral surface 168. The grip body 152 extends in the longitudinal direction of the spatula 140 to the stop 154, forming the second knob incongruity 182 and the fourth knob incongruity 184 in the lateral surface 168 of the grip 144, directly between the stop 154 and the grip body 152.

A shaft 190 extends from the grip 144 in the longitudinal direction of the spatula 140, where the grip 144 is fixed to a proximal end 192 of the shaft 190 by a utensil mount 194. A head 200 is fixed to a distal end 202 of the spatula 140 such that the shaft 190 is interposed between and separates the grip 144 and the head 200 along the longitudinal direction of the spatula 140. The head 200 is a body configured for maneuvering food items in the interior of the first pan 102 and the interior of the second pan 120. The grip 144 is fixed with the head 200 through the shaft 190 and extends from the shaft 190 and the head 200 in the longitudinal direction of the spatula 140. While, as depicted, the head 200 is integrally formed with the shaft 190, the head 200 may be otherwise fixed to the shaft 190 without departing from the scope of the present disclosure. In an embodiment, the head 200 is removably fixed with the shaft 190 and configured for being replaced with a variety of utensil end portions configured for maneuvering food items in the interior of the first pan 102 and the interior of the second pan 120.

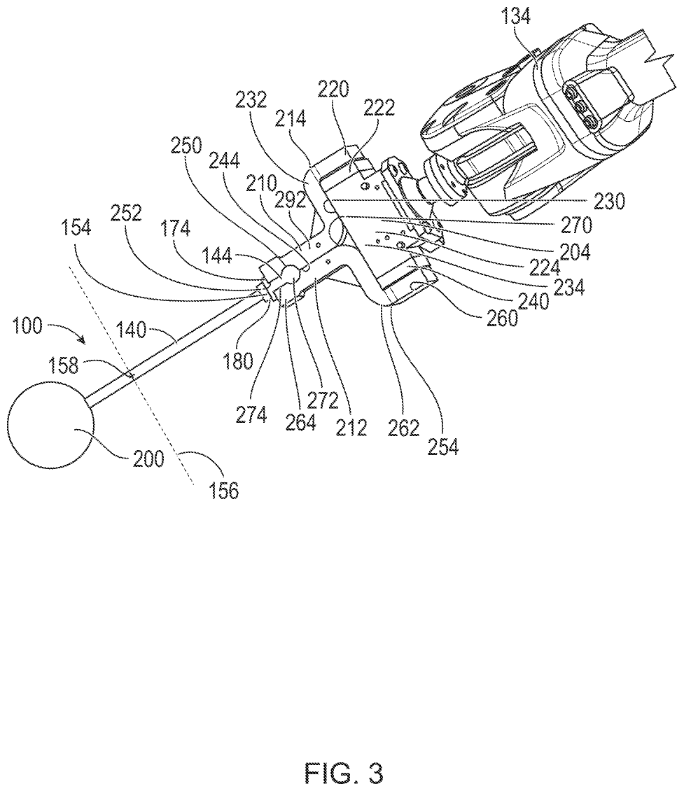

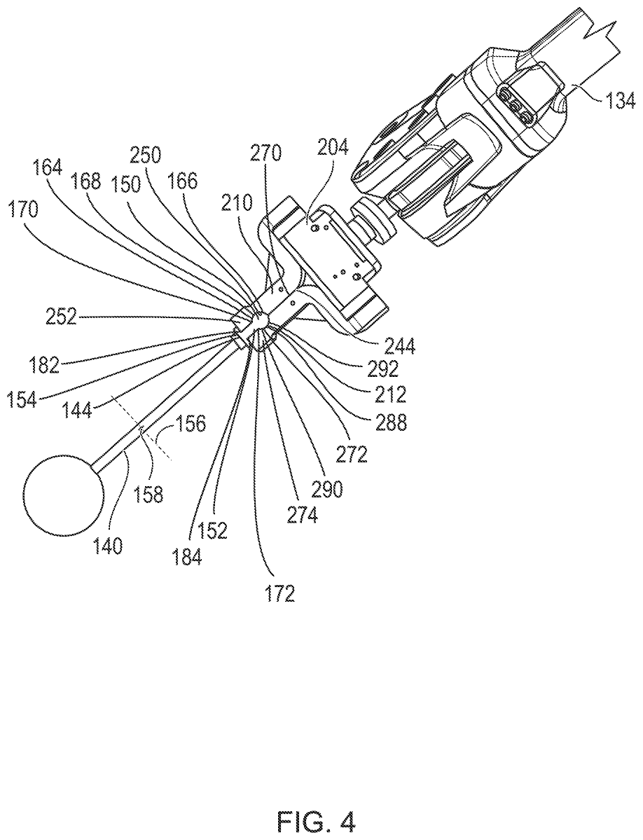

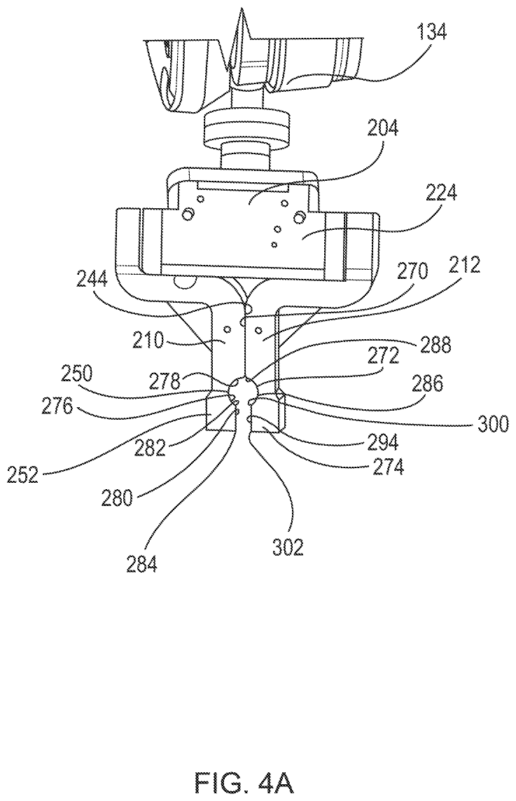

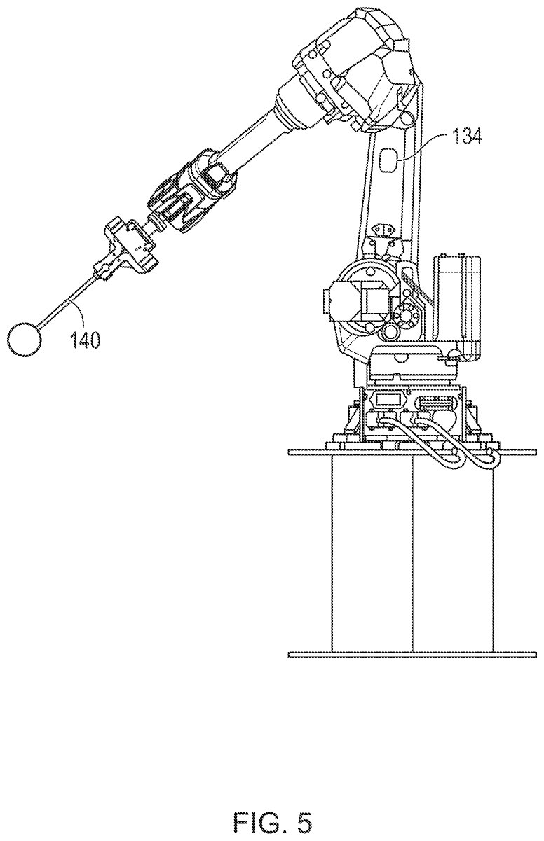

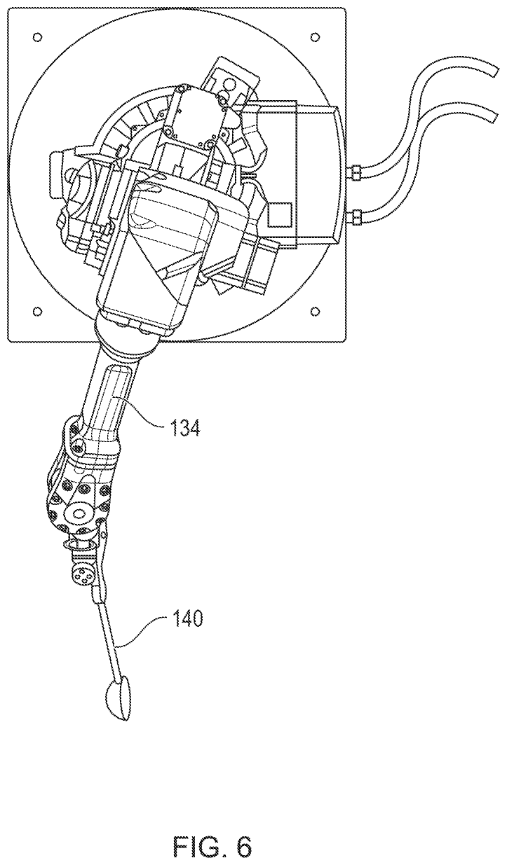

FIGS. 3-6 depict the robot arm 134 holding the spatula 140 at the grip 144, where FIGS. 3 and 4 depict a partial perspective view of the robot arm 134 holding the spatula 140, FIG. 5 depicts a side view of the robot arm 134 holding the spatula 140, and FIG. 6 depicts a top view of the robot arm 134 holding the spatula 140. With reference to FIG. 3, the robot arm 134 is engaged with the first pan 102 through an end effector 204 fixed to the robot arm 134. The end effector 204 includes a first finger 210 and a second finger 212 configured for gripping the grip 144 such that the robot arm 134 is capable of maneuvering the spatula 140 about the kitchen station 100 from the grip 144, including inserting the head 200 into the interior of the first pan 102 and the interior of the second pan 120.

The first finger 210 has a proximal end portion 214 fixed to a first plunger 220 supported on a first end portion 222 of a hand 224 included in the end effector 204, where the proximal end portion 214 extends from the first plunger 220 around the hand 224 from the first end portion 222 toward a front side 230 of the hand 224, forming a first shoulder 232 in the first finger 210. The first finger 210 extends from the first shoulder 232 toward a middle portion 234 of the hand 224 that is interposed between and separates the first end portion 222 and a second end portion 240 of the hand 224, the second end portion 240 being disposed on a side of the hand 224 opposite from the first end portion 222. A distal end portion 242 of the first finger 210 extends away from the front side 230 of the hand 224 at the middle portion 234, along the longitudinal direction of the spatula 140 when the end effector 204 is holding the grip 144.

A first inner surface 244 of the first finger 210 includes a rounded portion 250 complementary with the lateral surface 168 of the grip 144 at the cylindrical shape of the knob 150, and a flat portion 252 complementary with the lateral surface 168 of the grip 144 at the rectangular prism shape of the grip body 152. The rounded portion 250 and the flat portion 252 are extended in the second lateral direction 158 of the spatula 140 with the knob 150 and the grip body 152 when the end effector 204 is holding the grip 144. In this manner, the first inner surface 244 is complementary with the lateral surface 168 of the grip 144 such that when the end effector 204 is holding the grip 144, the rounded portion 250 of the first inner surface 244 contacts the lateral surface 168 of the grip 144 at the knob 150 and the flat portion 252 of the first inner surface 244 contacts the grip body 152. With this construction, the first inner surface 244 of the first finger 210 contacts the lateral surface 168 of the grip 144 on each side of the first knob incongruity 170 in the longitudinal direction of the spatula 140, with contact between the first inner surface 244 and the lateral surface 168 made along the second lateral direction 158 of the spatula 140 when the end effector 204 is holding the grip 144.

With continued reference to FIG. 3, when the end effector 204 is holding the grip 144, the first inner surface 244 extends in the longitudinal direction of the spatula 140 along the grip 144 and terminates at the first flange 174 of the stop 154. Because the first flange 174 of the stop 154 extends in the first lateral direction 156 of the spatula 140 beyond the grip body 152 to form the second knob incongruity 182, and because the flat portion 252 of the first inner surface 244 is complementary with the lateral surface 168 of the grip 144 at the grip body 152, the flat portion 252 of the first inner surface 244, and by extension the first finger 210 as a whole, is obstructed from movement beyond the stop 154 at the first flange 174 in the longitudinal direction of the spatula 140. The first knob incongruity 170 is similarly configured to obstruct the flat portion 252 of the first inner surface 244 from movement beyond the knob 150 in the longitudinal direction of the spatula 140, and in this manner the flat portion 252 of the first inner surface 244 is locked between the first knob incongruity 170 and the second knob incongruity 182 with respect to the longitudinal direction of the spatula 140 when the end effector 204 is holding the grip 144. Because the rounded portion 250 of the first inner surface 244 is complementary with the lateral surface 168 of the grip 144 in circular shape of the knob 150, the knob 150 is configured to obstruct the rounded portion 250, and by extension the first finger 210 as a whole, from movement in the longitudinal direction of the spatula 140 relative to the grip 144.

Further, because the rounded portion 250 of the first inner surface 244 is complementary with the lateral surface 168 of the grip 144 at the knob 150, and because the first inner surface 244 terminates at the first flange 174 of the stop 154, the first finger 210 is obstructed from rotating in the first lateral direction 156 of the spatula 140 relative to the grip 144 when the end effector 204 is holding the grip 144. Also because the flat portion 252 of the first inner surface 244 is complementary with the lateral surface 168 of the grip 144 at the grip body 152, and because the rounded portion 250 of the first inner surface 244 is complementary with the lateral surface 168 of the grip 144 in the circular shape of the knob 150, in the second lateral direction 158 of the spatula 140, the first finger 210 is obstructed from rotating in the longitudinal direction of the spatula 140 relative to the grip 144 when the end effector 204 is holding the grip 144. Also because the flat portion 252 of the first inner surface 244 is complementary with the lateral surface 168 of the grip 144 at the grip body 152, and because the first inner surface 244 terminates at the first flange 174, the first finger 210 is obstructed from rotating relative to the grip 144 in the second lateral direction 158 of the spatula 140 when the end effector 204 is holding the grip 144.

With continued reference to FIG. 3, the second finger 212 includes similar features, and functions in a similar manner as the first finger 210. The second finger 212 is mounted on a side of the hand 224 opposite the first finger 210 in the first lateral direction 156 of the spatula 140, the second finger 212 configured for being actuated with respect to the hand 224 and engaging a side of the grip 144 opposite the first finger 210 in the first lateral direction 156 of the spatula 140. To this end, the second finger 212 has a proximal end portion 254 fixed to a second plunger 260 supported on the second end portion 240 of the hand 224, where the proximal end portion 254 extends from the second plunger 260 around the hand 224 from the second end portion 240 toward the front side 230 of the hand 224, forming a second shoulder 262 in the second finger 212. The second finger 212 extends from the second shoulder 262 toward the middle portion 234 of the hand 224, and a distal end portion 264 of the second finger 212 extends away from the front side 230 of the hand 224 at the middle portion 234, along the longitudinal direction of the spatula 140 when the end effector 204 is holding the grip 144.

A second inner surface 270 of the second finger 212 includes a rounded portion 272 complementary with the lateral surface 168 of the grip 144 at the circular shape of the knob 150, and a flat portion 274 complementary with the lateral surface 168 of the grip 144 in the rectangular prism shape of the grip body 152, the rounded portion 272 and the flat portion 274 being extended in the second lateral direction 158 of the spatula 140 with the knob 150 and the grip body 152 when the end effector 204 is holding the grip 144. In this manner, the second inner surface 270 is complementary with the lateral surface 168 of the grip 144 such that when the end effector 204 is holding the grip 144, the rounded portion 272 of the second inner surface 270 contacts the lateral surface 168 of the grip 144 at the knob 150 and the flat portion 274 of the second inner surface 270 contacts the grip body 152. With this construction, the second inner surface 270 of the second finger 212 contacts the lateral surface 168 of the grip 144 on each side of the third knob incongruity 172 in the longitudinal direction of the spatula 140, with contact between the second inner surface 270 and the lateral surface 168 made along the second lateral direction 158 of the spatula 140 when the end effector 204 is holding the grip 144.

With continued reference to FIG. 3, when the end effector 204 is holding the grip 144, the second inner surface 270 extends in the longitudinal direction of the spatula 140 along the grip 144 and terminates at the second flange 180 of the stop 154. Because the second flange 180 of the stop 154 extends in the first lateral direction 156 of the spatula 140 beyond the grip body 152 to form the fourth knob incongruity 184, and because the flat portion 274 of the second inner surface 270 is complementary with the lateral surface 168 of the grip 144 at the grip body 152, the flat portion 274 of the second inner surface 270, and by extension the second finger 212 as a whole, is obstructed from movement beyond the stop 154 at the second flange 180 in the longitudinal direction of the spatula 140. The third knob incongruity 172 is similarly configured to obstruct the flat portion 274 of the second inner surface 270 from movement beyond the knob 150 in the longitudinal direction of the spatula 140, and in this manner the flat portion 274 of the second inner surface 270 is locked between the third knob incongruity 172 and the fourth knob incongruity 184 with respect to the longitudinal direction of the spatula 140 when the end effector 204 is holding the grip 144.

Further, because the rounded portion 272 of the second inner surface 270 is complementary with the lateral surface 168 of the grip 144 in the circular shape of the knob 150, the knob 150 is configured to obstruct the rounded portion 272, and by extension the second finger 212 as a whole, from movement in the longitudinal direction of the spatula 140 relative to the grip 144. Because the rounded portion 272 of the second inner surface 270 is complementary with the lateral surface 168 of the grip 144 at the knob 150, and because the second inner surface 270 terminates at the second flange 180 of the stop 154, the second finger 212 is obstructed from rotating in the first lateral direction 156 of the spatula 140 relative to the grip 144 when the end effector 204 is holding the grip 144. Also because the flat portion 274 of the second inner surface 270 is complementary with the lateral surface 168 of the grip 144 at the grip body 152, and because the rounded portion 272 of the second inner surface 270 is complementary with the lateral surface 168 of the grip 144 in the circular shape of the knob 150, in the second lateral direction 158 of the spatula 140, the second finger 212 is obstructed from rotating in the longitudinal direction of the spatula 140 relative to the grip 144 when the end effector 204 is holding the grip 144. Also because the flat portion 274 of the second inner surface 270 is complementary with the lateral surface 168 of the grip 144 at the grip body 152, and because the second inner surface 270 terminates at the second flange 180, the second finger 212 is obstructed from rotating relative to the grip 144 in the second lateral direction 158 of the spatula 140 when the end effector 204 is holding the grip 144.

FIG. 4 depicts the robot arm 134 holding the spatula 140 at the grip 144 through the end effector 204, and FIG. 4A depicts an enlarged view of the end effector 204 actuated to a position configured for holding the spatula 140 at the grip 144 as shown in FIG. 4. With reference to FIG. 4A, the first finger 210 forms a first inclined surface 276 and a second inclined surface 278 on the rounded portion 250 of the first inner surface 244. As shown between FIGS. 4 and 4A, the first inclined surface 276 and the second inclined surface 278 of the first finger 210 are respectively configured for engaging and extending along the first inclined surface 164 and the second inclined surface 166 of the knob 150 in the longitudinal direction and the first lateral direction 156 of the spatula 140. The first inclined surface 276 and the second inclined surface 278 of the first finger 210 are rounded toward the grip body 152 in the first lateral direction 156 of the spatula 140 so as to extend along and engage the first inclined surface 164 and the second inclined surface 166 of the knob 150 in the longitudinal direction and the first lateral direction 156 of the spatula 140. In this manner, the first inclined surface 276 and the second inclined surface 278 of the first finger 210 are respectively configured for engaging the knob 150 at opposite sides of the knob 150 in the longitudinal direction of the spatula 140.

The first inclined surface 276 of the first finger 210 is inclined toward the grip body 152 in the first lateral direction 156 of the spatula 140, and toward the stop 154 in the longitudinal direction of the spatula 140. With this construction, because the first inclined surface 164 of the knob 150 is inclined outward from the grip body 152 in the first lateral direction 156 of the spatula 140, and away from the stop 154 in the longitudinal direction of the spatula 140, the knob 150 is configured to press the flat portion 252 of the first finger 210 at a first longitudinal end surface 280 the first finger 210, toward the stop 154 in the longitudinal direction of the spatula 140 when the first finger 210 engages the grip 144 in the first lateral direction 156 of the spatula 140.

The second inclined surface 278 of the first finger 210 is inclined toward the grip body 152 in the first lateral direction 156 of the spatula 140, and away from the stop 154 in the longitudinal direction of the spatula 140. With this construction, because the second inclined surface 166 of the knob 150 is inclined toward the grip body 152 in the first lateral direction 156 of the spatula 140, and away from the stop 154 in the longitudinal direction of the spatula 140, the knob 150 is configured to press the flat portion 252 of the first finger 210 at the first longitudinal end surface 280 the first finger 210, away from the stop 154 in the longitudinal direction of the spatula 140 when the first finger 210 engages the grip 144. In this manner, the first inclined surface 164 and the second inclined surface 166 of the knob 150, and the first inclined surface 276 and the second inclined surface 278 of the first finger 210 are configured for locating the flat portion 252 on the grip body 152 between the knob 150 and the stop 154 in the longitudinal direction of the spatula 140.

The first inclined surface 276 and the second inclined surface 278 of the first finger 210 extend straight in the second lateral direction 158 of the spatula 140. With this construction, the first inclined surface 276 and the second inclined surface 278 of the first finger 210 are complementary to the lateral surface 168 of the grip 144 in the second lateral direction 158 of the spatula 140, and configured for engaging the lateral surface 168 of the grip 144 along the second lateral direction 158 of the spatula 140.

As shown in FIG. 4A, the first finger 210 forms the first longitudinal end surface 280 on the flat portion 252 of the first inner surface 244. The first longitudinal end surface 280 extends from the first inclined surface 276 of the first finger 210 in the longitudinal direction of the spatula 140, and is configured for extending along the grip body 152 and engaging the stop 154 in the longitudinal direction of the spatula 140.

As shown between FIGS. 4 and 4A, the first longitudinal end surface 280 is complementary with the lateral surface 168 of the grip 144 at the grip body 152 for engaging the grip body 152 in the first lateral direction 156 of the spatula 140. The lateral surface 168 of the grip 144 at the grip body 152 is defined by the rectangular prism shape of the grip body 152. As such, the grip body 152 forms a planar surface that extends in the longitudinal direction and the second lateral direction 158 of the spatula 140, and the first longitudinal end surface 280 is planar and extends straight in the longitudinal direction and the second lateral direction 158 of the spatula 140, along the grip body 152. With this construction, the first longitudinal end surface 280 is configured to engage the grip body 152 in the first lateral direction 156 of the spatula 140, between the knob 150 and the stop 154 in the longitudinal direction of the spatula 140.

The first longitudinal end surface 280 is configured to engage the stop 154 and the first inclined surface 164 of the knob 150 in the longitudinal direction of the spatula 140, along the grip body 152 in the second lateral direction 158 of the spatula 140. The first flange 174 forms a planar surface extended in the first lateral direction 156 and the second lateral direction 158 of the spatula 140 such that the planar surface of the first flange 174 engages the first longitudinal end surface 280 in the longitudinal direction of the spatula 140, along the second lateral direction 158 of the spatula 140.

The first longitudinal end surface 280 of the first finger 210 extends to the first inclined surface 276 of the first finger 210 in the longitudinal direction of the spatula 140, forming a first finger incongruity 282 in the first finger 210 directly between the first inclined surface of the knob 150 and the first longitudinal end surface 280. The first finger incongruity 282 is defined in the first inner surface 244 of the first finger 210 at the first inclined surface 276, and configured for engaging the first knob incongruity 170 defined in the lateral surface 168 of the grip 144 at the knob 150.

With continued reference to FIGS. 4 and 4A, the first longitudinal end surface 280 of the first finger 210 extends in the longitudinal direction of the spatula 140, forming a second finger incongruity 284 in the first finger 210 along the first longitudinal end surface 280. The second finger incongruity 284 is defined in the first inner surface 244 of the first finger 210, along the first longitudinal end surface 280, and configured for engaging the second knob incongruity 182 defined in the lateral surface 168 of the grip 144. With the first finger incongruity 282 in the first finger 210 engaging the first knob incongruity 170 in the knob 150, and the second finger incongruity 284 in the first finger 210 engaging the second knob incongruity 182, the flat portion 252 of first finger 210 is interlocked with the grip 144 between the knob 150 and the stop 154 in the longitudinal direction of the spatula 140. The first longitudinal end surface 280 is configured to directly engage the stop 154, the grip body 152, and the first inclined surface 164 of the knob 150, and the first inclined surface 276 of the first finger 210 is configured to directly engage the first inclined surface 164 of the knob 150.

The second finger 212 forms a third inclined surface 286 and a fourth inclined surface 288 on the rounded portion 272 of the second inner surface 270. The third inclined surface 286 and the fourth inclined surface 288 of the second finger 212 are respectively configured for engaging and extending along a third inclined surface 290 and a fourth inclined surface 292 of the knob 150 in the longitudinal direction and the first lateral direction 156 of the spatula 140. The third inclined surface 286 and the fourth inclined surface 288 of the second finger 212 are rounded toward the toward the grip body 152 in the first lateral direction 156 of the spatula 140 so as to extend along and engage the first inclined surface 164 and the second inclined surface 166 of the knob 150 in the longitudinal direction and the first lateral direction 156 of the spatula 140.

The knob 150 forms the third inclined surface 290 and the fourth inclined surface 292 on a side of the grip 144 opposite the first inclined surface 164 and the second inclined surface 166 in the first lateral direction 156 of the spatula 140. The third inclined surface 290 of the knob 150 is inclined outward from the grip body 152 in the first lateral direction 156 of the spatula 140, and away from the stop 154 in the longitudinal direction of the spatula 140. The fourth inclined surface 292 of the knob 150 is inclined outward from the grip body 152 in the first lateral direction 156 of the spatula 140, and toward the stop 154 in the longitudinal direction of the spatula 140.

The third inclined surface 290 and the fourth inclined surface 292 of the knob 150 respectively include similar features and function in a similar manner as the first inclined surface 164 and the second inclined surface 166 of the knob 150, with like features having opposite orientations in the first lateral direction 156 of the spatula 140. The third inclined surface 286 and the fourth inclined surface 288 of the second finger 212 respectively include similar features and function in a similar manner as the first inclined surface 276 and the second inclined surface 278 of the first finger 210, with like features having opposite orientations in the first lateral direction 156 of the spatula 140.

With continued reference to FIGS. 4 and 4A, the second finger 212 forms a second longitudinal end surface 294 on the flat portion 274 of the second inner surface 270. The second longitudinal end surface 294 extends from the third inclined surface 286 of the second finger 212 in the longitudinal direction of the spatula 140, and is configured for extending along the grip body 152 and engaging the stop 154 in the longitudinal direction of the spatula 140.

The second longitudinal end surface 294 is complementary with the lateral surface 168 of the grip 144 at the grip body 152 for engaging the grip body 152 in the first lateral direction 156 of the spatula 140. The second longitudinal end surface 294 of the second finger 212 includes similar features and functions in a similar manner as the first longitudinal end surface of the first finger 210 for engaging the lateral surface 168 of the grip 144, with like features having opposite orientations in the first lateral direction 156 of the spatula 140.

The second longitudinal end surface 294 of the second finger 212 extends to the third inclined surface 286 of the second finger 212 in the longitudinal direction of the spatula 140, forming a third finger incongruity 300 in the second finger 212 directly between the third inclined surface 290 of the knob 150 and the second longitudinal end surface 294. The third finger incongruity 300 is defined in the second inner surface 270 of the second finger 212 at the third inclined surface 286, and configured for engaging the third knob incongruity 172 defined in the lateral surface 168 of the grip 144 at the knob 150.

With continued reference to FIGS. 4 and 4A, the second longitudinal end surface 294 of the second finger 212 extends in the longitudinal direction of the spatula 140, forming a fourth finger incongruity 302 in the second finger 212 along the second longitudinal end surface 294. The fourth finger incongruity 302 is defined in the second inner surface 270 of the second finger 212, along the second longitudinal end surface 294, and configured for engaging the fourth knob incongruity 184 defined in the lateral surface 168 of the grip 144. With the first finger incongruity 282 in the first finger 210 engaging the first knob incongruity 170 in the knob 150, and the second finger incongruity 284 in the first finger 210 engaging the second knob incongruity 182, the flat portion 252 of first finger 210 is interlocked with the grip 144 between the knob 150 and the stop 154 in the longitudinal direction of the spatula 140. The first longitudinal end surface 280 is configured to directly engage the stop 154, the grip body 152, and the first inclined surface 164 of the knob 150, and the first inclined surface 164 of the first finger 210 is configured to directly engage the first inclined surface 164 of the knob 150.

The first knob incongruity 170, the third knob incongruity 172, the second knob incongruity 182, and the fourth knob incongruity 184 formed in the grip 144 are corners of the lateral surface 168 of the grip 144 which extend to opposite sides of the grip 144 in the second lateral direction 158 of the spatula 140. The first finger incongruity 282, the second finger incongruity 284, the third finger incongruity 300, and the fourth finger incongruity 302 formed in the first finger 210 and the second finger 212 are corners in the first inner surface 244 and the second inner surface 270 which extend to opposite sides of the first finger 210 and the second finger 212 in the second lateral direction 158 of the spatula 140.

The first finger incongruity 282 in the first finger 210 is configured for engaging the first knob incongruity 170 in the first lateral direction 156 of the spatula 140, and being aligned with the first knob incongruity 170 in the second lateral direction 158 of the spatula 140. The second finger incongruity 284 in the first finger 210 is configured for engaging the second knob incongruity 182 in the first lateral direction 156 of the spatula 140, and being aligned with the second knob incongruity 182 in the second lateral direction 158 of the spatula 140. The third finger incongruity 300 in the second finger 212 is configured for engaging the third knob incongruity 172 in the first lateral direction 156 of the spatula 140, and being aligned with the third knob incongruity 172 in the second lateral direction 158 of the spatula 140. The fourth finger incongruity 302 in the second finger 212 is configured for engaging the fourth knob incongruity 184 in the first lateral direction 156 of the spatula 140, and being aligned with the fourth knob incongruity 184 in the second lateral direction 158 of the spatula 140.

The shaft 190 and the first inclined surface 276 of the first finger 210 are rounded with respect to the longitudinal direction of the spatula 140 such that the first inclined surface 276 of the first finger 210 is configured to extend around and engage the shaft 190 in the first lateral direction 156 of the spatula 140. The first inclined surface 276 and the second inclined surface 278 of the first finger 210 are formed with a radius of curvature at least as large as the shaft 190 with respect to the longitudinal direction of the spatula 140. In an embodiment, the first inclined surface 276 and the second inclined surface 278 of the first finger 210 are formed with a radius of curvature larger than the shaft 190 with respect to the longitudinal direction of the spatula 140. With this construction, the rounded portion 250 of the first inner surface 244 is configured for receiving and gripping the shaft 190 between the first inclined surface 276 and the second inclined surface 278 of the first finger 210.

With reference to FIG. 3, while the depicted end effector 204 includes the first finger 210 with the first inner surface 244 and the second finger 212 with the second inner surface 270, where the first inner surface 244 and the second inner surface 270 are respectively complementary with the knob incongruities 170, 172, 182, 184 in the lateral surface 168 of the grip 144 to prevent movement of the first finger 210 and the second finger 212 relative to the grip 144 when the end effector 204 is holding the grip 144, one of the first finger 210 and the second finger 212 may alternatively feature an inner surface configured for pressing the lateral surface 168 of the grip 144 toward a complementary in the other of the first finger 210 and the second finger 212 for obstructing movement of the end effector 204 relative to the grip 144 when the end effector 204 is holding the grip 144 without departing from the scope of the present disclosure. Also, while the depicted grip 144 features the knob incongruities 170, 172, 182, 184 formed in the lateral surface 168 of the grip 144 between features of the knob 150, the grip body 152, and the stop 154, the lateral surface 168 of the grip 144 may alternatively feature incongruities otherwise configured for engaging one of the first finger 210 and the second finger 212 to obstruct movement of the end effector 204 relative to the grip 144 when the end effector 204 is holding the grip 144. Also, while the depicted end effector 204 includes the first finger 210 with the first inner surface 244 complementary with the lateral surface 168 of the grip 144, and includes and the second finger 212 with the second inner surface 270 complementary with the lateral surface 168 of the grip 144 for holding the grip 144 with the first finger 210, the end effector 204 may additionally or alternatively include fingers similar to the first finger 210 and the second finger 212 which are complementary with and configured for engaging additional surfaces of the grip 144, which may also include incongruities similar to the knob incongruities 170, 172, 182, 184 in the lateral surface 168 of the grip 144, to obstruct movement of the end effector 204 relative to the grip 144 when the end effector 204 is holding the grip 144 without departing from the scope of the present disclosure.

While the first finger 210 and the second finger 212 extend toward the middle portion 234 of the hand 224 and respectively include the first shoulder 232 and the second shoulder 262, the first finger 210 and the second finger 212 may alternatively extend toward the first end portion 222 of the hand 224 such that the first finger 210 and the second finger 212 are configured for holding the grip 144 while the first finger 210 lacks a shoulder, or alternatively extend toward the second end portion 240 of the hand 224 such that the first finger 210 and the second finger 212 are configured for holding the grip 144 while the second finger 212 lacks a shoulder without departing from the scope of the present disclosure. In an embodiment where the first finger 210 and the second finger 212 extend from the first end portion 222 of the hand 224, the first finger 210 extends straight outward from the hand 224 and does not include a shoulder. In an embodiment where the first finger 210 and the second finger 212 extend from the second end portion 240 of the hand 224, the second finger 212 extends straight outward from the hand 224 and does not include a shoulder.

The first finger 210 and the second finger 212 are mounted on the hand 224 and configured for being actuated with respect to the hand 224 and engaging the grip 144 in the first lateral direction 156 of the spatula 140, where the first inner surface 244 of the first finger 210 and the second inner surface 270 of the second finger 212 directly engage the lateral surface 168 of the grip 144. The hand 224 is configured to actuate the first finger 210 through the first plunger 220 by extending and retracting the first plunger 220, and by extension the first finger 210, in the first lateral direction 156 of the spatula 140 when the end effector 204 is holding the grip 144. The hand 224 is configured to actuate the second finger 212 through the second plunger 260 by extending and retracting the second plunger 260, and by extension the second finger 212, in the first lateral direction 156 of the spatula 140 when the end effector 204 is holding the grip 144. In this manner, the grip 144 is configured for receiving the first inner surface 244 of the first finger 210 and the second inner surface 270 of the second finger 212 at the lateral surface 168 of the grip 144 when the end effector 204 is holding the spatula 140. In an embodiment, the first plunger 220 and the second plunger 260 are respectively driven by the hand 224 with a servomechanism disposed in the hand 224, however alternative driving mechanisms, such as solenoids, may be employed for driving the first plunger 220 and the second plunger 260 in the lateral direction of the hand 224 without departing from the scope of the present disclosure.

In an embodiment, the hand 224 is configured to independently actuate each of the first plunger 220 and the second plunger 260. In an alternative embodiment, the hand is configured to actuate one of the first finger 210 and the second finger 212 for holding the grip 144 between the first finger 210 and the second finger 212.

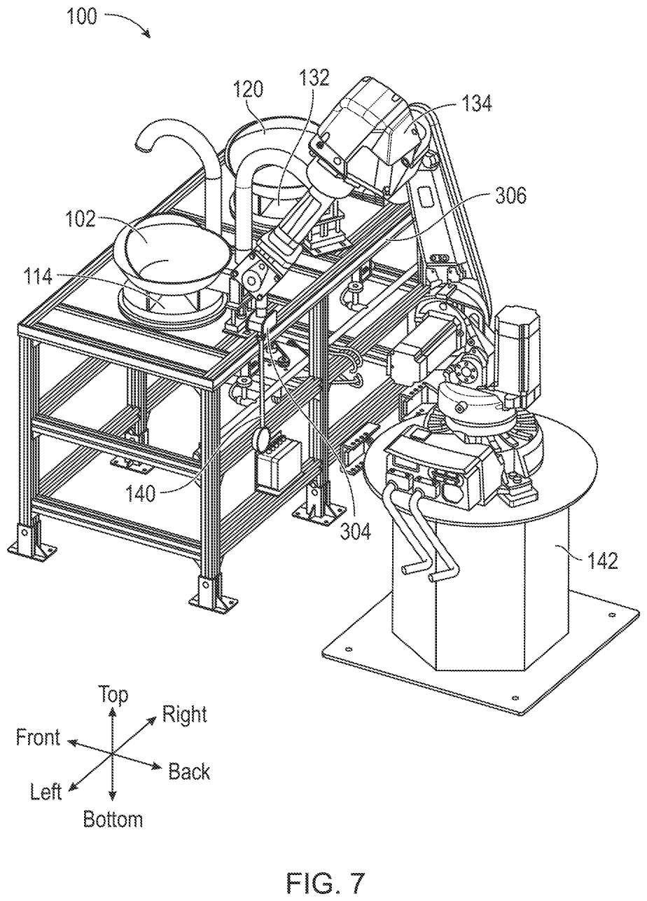

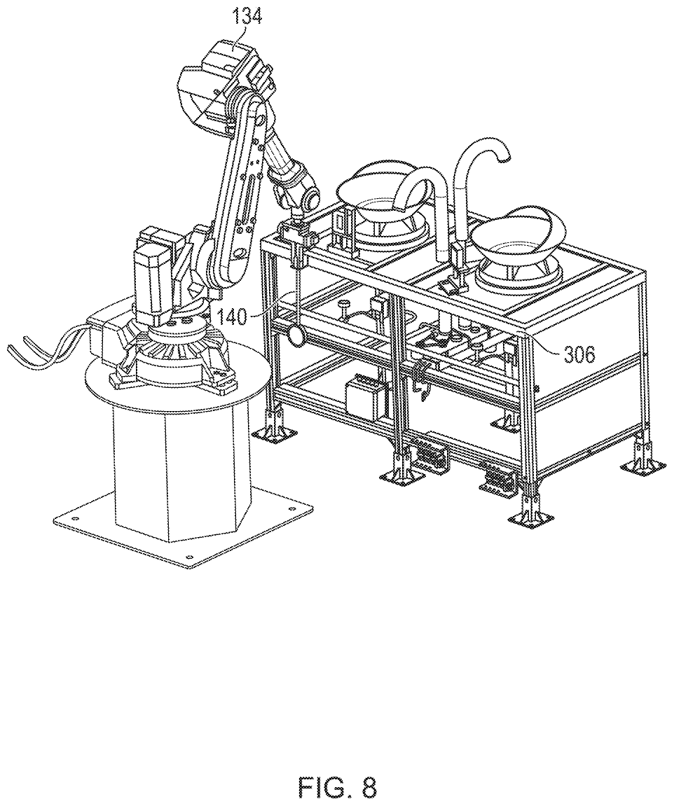

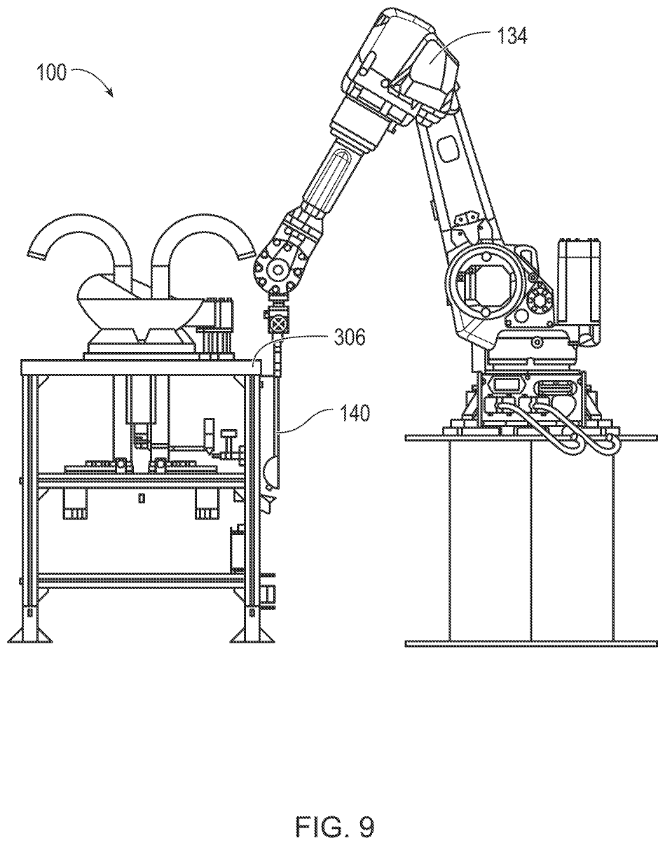

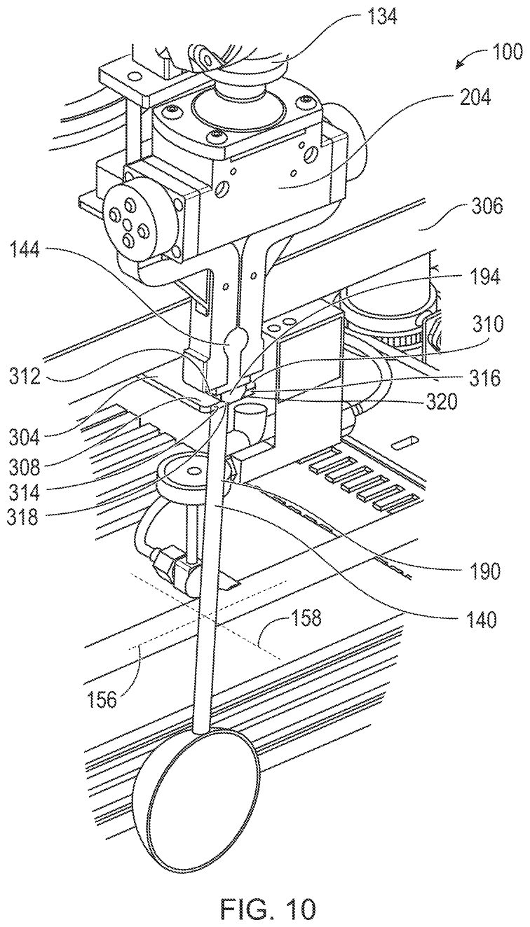

FIGS. 7-10 depict the robot arm 134 placing the spatula on an intermediate holder 304 mounted on a front side 306 of the kitchen station 100 between the base 142, the first stove 114, and the second stove 132, where FIGS. 7 and 8 depict a perspective view of the robot arm 134 at the kitchen station 100, FIG. 9 depicts a side view of the robot arm 134 at the kitchen station 100, and FIG. 10 depicts a partial perspective view of the robot arm 134 at the kitchen station 100 including the spatula 140, the end effector 204, and the intermediate holder 304. As depicted, the spatula 140 is configured for being retained in a vertical orientation at the front side 306 of the kitchen station 100 with respect to a top-bottom direction of the kitchen station 100. In FIG. 7, the intermediate holder 304 is fixed to the front side 306 of the kitchen station 100 between the base 142, the first stove 114, and the second stove 132 with respect to a front-back direction of the kitchen station 100 that is a first lateral direction of the kitchen station 100, and a left-right direction of the kitchen station 100 that is a second lateral direction of the kitchen station 100.

As shown in FIG. 10, the intermediate holder 304 extends from the front side 306 of the kitchen station 100 in the front-back direction of the kitchen station 100. The intermediate holder 304 includes a first projection 308 and a second projection 310 extended in the front-back direction of the kitchen station 100. The first projection 308 and the second projection 310 are spaced from each other to define a gap 312 therebetween in the left-right direction of the kitchen station 100.

The utensil mount 194 has a width greater than the gap 312 defined between the first projection 308 and the second projection 310 in the second lateral direction of the kitchen station 100. The first projection 308 and the second projection 310 are spaced from each other in the second lateral direction of the kitchen station 100 so as to catch the utensil mount 194, obstructing the utensil mount 194 and by extension the spatula 140 from moving downward beyond the intermediate holder 304 with respect to the top-bottom direction of the kitchen station 100. In this manner, the intermediate holder 304 is configured to support the spatula 140 by the utensil mount 194 at the front side 306 of the kitchen station 100 between the first projection 308 and the second projection 310 in the second lateral direction of the kitchen station 100.

The utensil mount 194 is fixed with the grip 144 and the proximal end 192 of the shaft 190 such that the utensil mount 194 is interposed between and separates the grip 144 and each of the shaft 190 and the head 200 in the longitudinal direction of the spatula 140. The shaft 190 has a width smaller than the gap 312 defined between the first projection 308 and the second projection 310 such that the gap 312 is configured to receive the shaft 190 in the first lateral direction of the kitchen station 100 and support the spatula 140 at the utensil mount 194. The first projection 308 and the second projection 310 are spaced from each other in the left-right direction of the kitchen station 100 a distance corresponding to a width of the shaft 190 of the spatula 140 taken in the first lateral direction 156 of the spatula 140, such that the intermediate holder 304 is configured for receiving the shaft 190 in a front-back direction of the kitchen station 100, between the first projection 308 and the second projection 310 in the left-right direction of the kitchen station 100.

The first projection 308 and the second projection 310 are each formed with a wedge shape extended in the front-back direction of the kitchen station such that the first projection 308 includes a first inclined face 314 that faces upward with respect to the top-bottom direction of the kitchen station 100 and is inclined in the left-right direction of the kitchen station toward the second projection 310, and such that the second projection 310 includes a second inclined face 316 that faces upward with respect to the top-bottom direction of the kitchen station 100 and is inclined in the left-right direction of the kitchen station 100 toward the first projection 308. The utensil mount 194 includes inclined faces complementary with the first inclined face 314 and the second inclined face 316 of the intermediate holder 304 such that when the utensil mount 194 is placed in the intermediate holder 304, a weight of the spatula 140 centers the utensil mount 194 on the intermediate holder 304 with respect to the left-right direction of the kitchen station 100. To this end, the utensil mount 194 includes a third inclined face 318 inclined toward the longitudinal direction of the spatula 140, and a fourth inclined face 320 located on a side of the utensil mount 194 opposite the third inclined face 318, where the fourth inclined face 320 is inclined toward the third inclined face 318, and is inclined toward the longitudinal direction of the spatula 140.

With this construction, when the spatula 140 is placed on and resting in the intermediate holder 304, the first inclined face 314 on the first projection 308 contacts the third inclined face 318 on the utensil mount 194, and the second inclined face 316 on the second projection 310 contacts the fourth inclined face 320 on the utensil mount 194, where contact between the first inclined face 314 and the third inclined face 318 and contact between the second inclined face 316 and the fourth inclined face 320 centers the utensil mount 194 on the intermediate holder 304 in the left-right direction of the kitchen station 100. While the depicted utensil mount 194 and intermediate holder respectively include two faces complementary with each other for centering the utensil mount 194 on the intermediate holder in the left-right direction of the kitchen station 100, the utensil mount 194 and the intermediate holder 304 may face fewer or additional complementary inclined surfaces for locating the utensil mount 194 on the intermediate holder 304 when the utensil mount 194 is placed on the intermediate holder 304 without departing from the scope of the present disclosure.

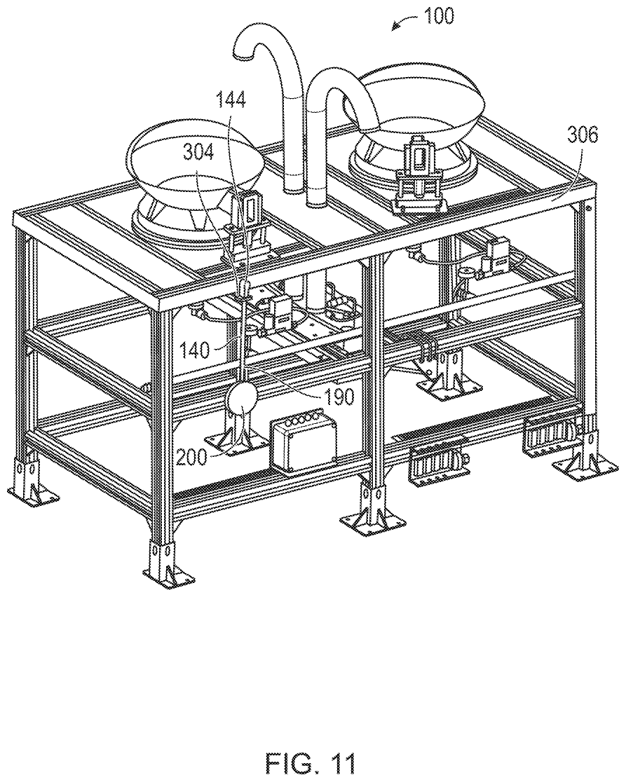

With the robot arm 134 being configured for selectively holding the grip 144 to maneuver the spatula 140 about the kitchen station 100, the robot arm 134 is configured to maneuver the spatula 140 in the front-back direction of the kitchen station 100 with the shaft 190 positioned between the first projection 308 and the second projection 310 in the left-right direction of the kitchen station 100 such that the intermediate holder 304 receives the shaft 190, and the robot arm 134 is configured to release the grip 144 such that the spatula 140 is supported on the intermediate holder 304 at the utensil mount 194. FIG. 11 depicts a perspective view of the kitchen station 100 with the spatula 140 supported in the intermediate holder 304.

As shown in FIG. 11, the spatula 140 is supported in the intermediate holder 304, independent from the robot arm 134. Notably, the shaft 190 and the head 200 of the spatula 140 may be alternatively formed as a lid, a fork, a spoon, a knife, a whisk, a strainer, a grater, or other cooking utensil for use at the kitchen station 100 without departing from the scope of the present disclosure. Further, the shaft 190 and the head 200 of the spatula 140 may be alternatively formed as a pan, a pot, a wok, a sauce pan, a sheet pan, a cooking sheet, a baking rack, or a similar cooking hardware otherwise configured for being maneuvered by the robot arm 134 through the grip 144 for use at the kitchen station 100 without departing from the scope of the present disclosure.

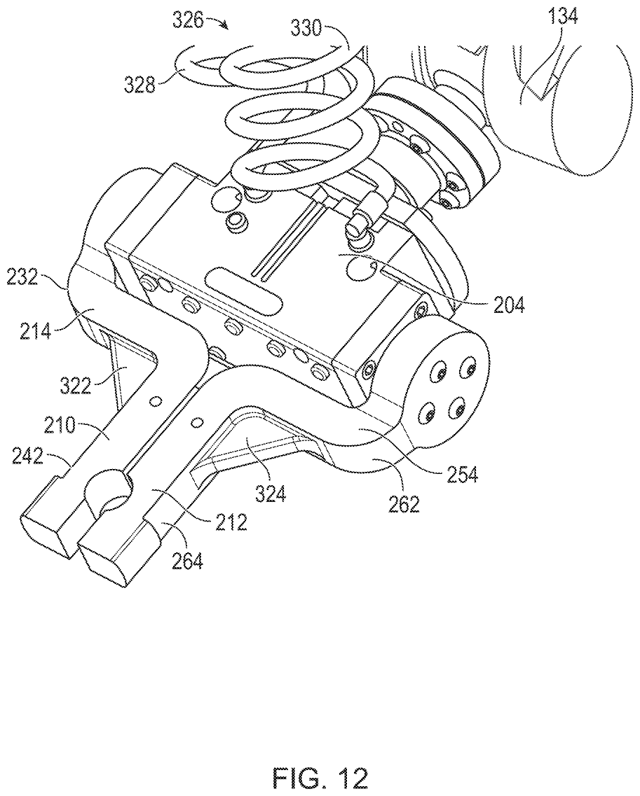

FIG. 12 depicts a partial perspective view of the robot arm 134 including the end effector 204. As shown in FIG. 12, the first finger 210 includes a first rib or gusset 322 connecting the proximal end portion 214 at the first shoulder 232 and the distal end portion 242 to support the distal end portion 242 from the proximal end portion 214 at the first shoulder 232. The second finger 212 includes a second rib or gusset 324 connecting the proximal end portion 254 at the second shoulder 262 and the distal end portion 264 to support the distal end portion 264 from the proximal end portion 254 at the second shoulder 262.

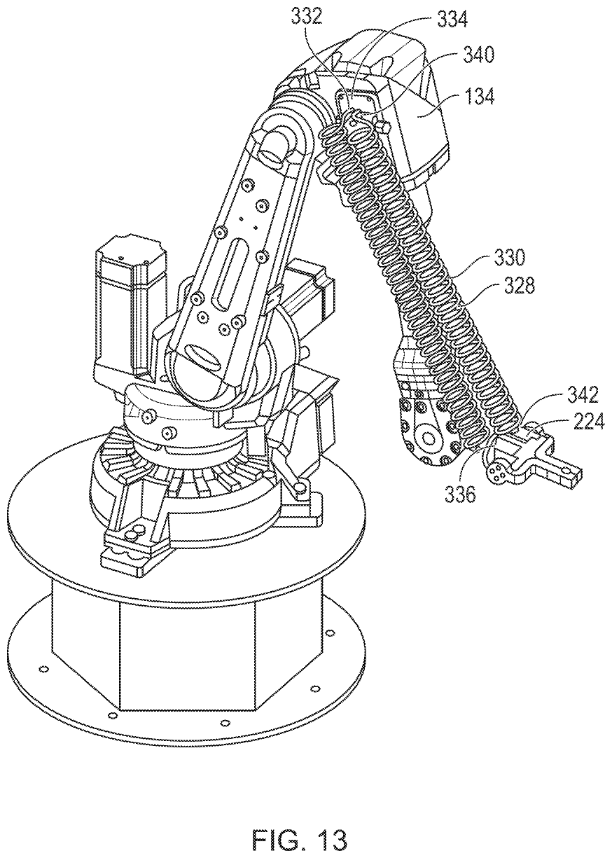

A linkage 326 formed from a first spring 328 and a second spring 330 connects the hand 224 and a portion of the robot arm 134 to support the hand 224 from the robot arm 134. FIG. 13 depicts a perspective view of the robot arm 134, where a proximal end 332 of the first spring 328 is fixed to a base plate 334 on the robot arm 134 and a distal end 336 of the first spring 328 is fixed to the hand 224 such that the first spring 328 connects the hand 224 and the robot arm 134, supporting the hand 224 from the base plate 334.

The second spring 330 includes similar features, and functions in a similar manner as the first spring 328. To this end, a proximal end 340 of the second spring 330 is fixed to the base plate 334 and a distal end 342 of the second spring 330 is fixed to the hand 224 such that the second spring 330 connects the hand 224 and the robot arm 134, supporting the hand 224 from the base plate 334.

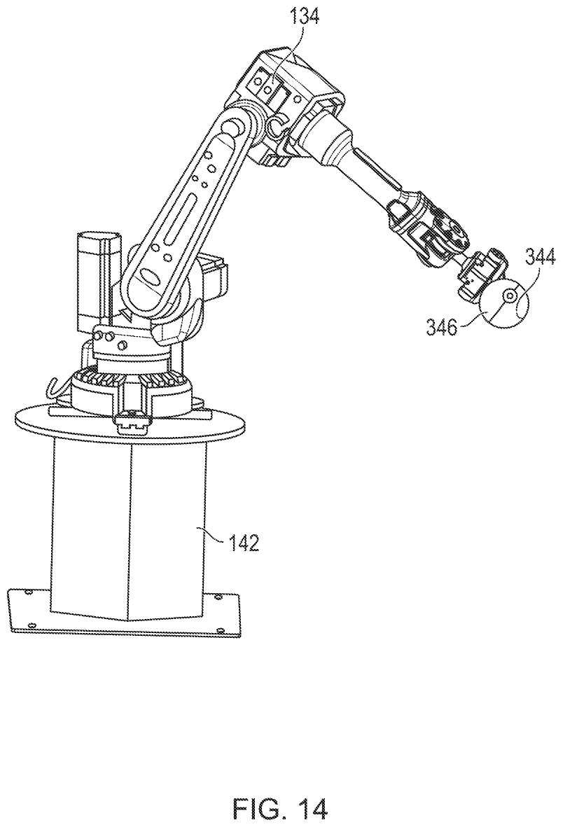

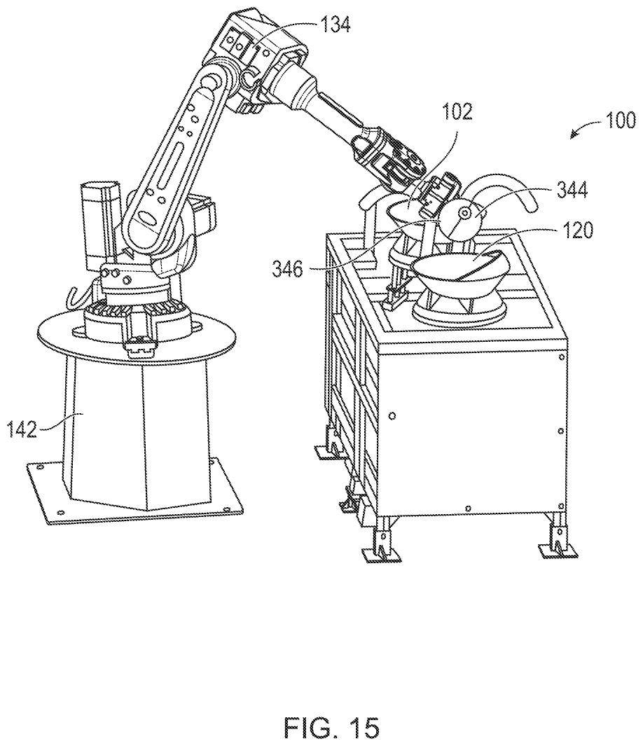

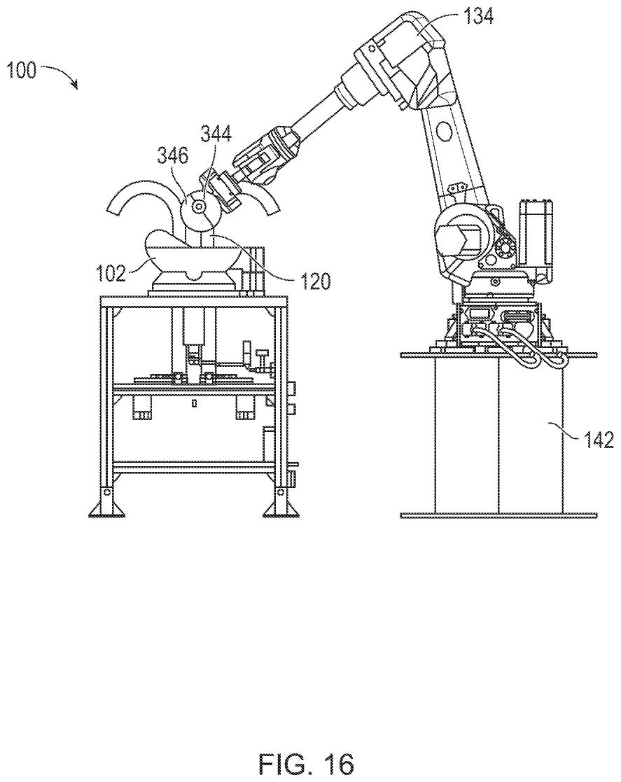

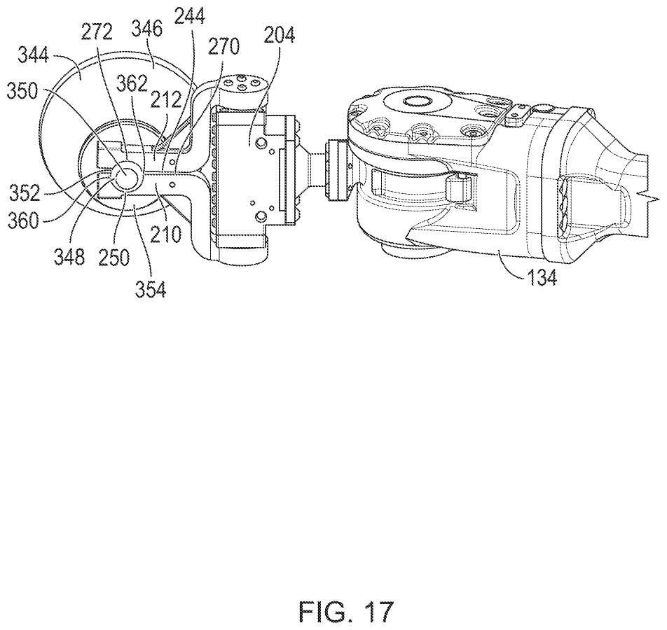

FIGS. 14-17 depict the robot arm 134 holding a cup 344 that is a body configured for maneuvering food items (not shown) at the kitchen station 100, where FIG. 14 depicts a perspective view of the robot arm 134 holding the cup 344, FIG. 15 depicts a perspective view of the robot arm 134 holding the cup 344 at the kitchen station 100, FIG. 16 depicts a side view of the robot arm 134 holding the cup 344 at the kitchen station 100, and FIG. 17 depicts a partial bottom perspective view of the robot arm 134 holding the cup 344. In FIG. 14, the robot arm 134 is supported by, and fixed on the base 142 at the kitchen station 100 within a reaching range of the robot arm 134 with the cup 344 such that the robot arm 134 is capable of reaching the interior of the first pan 102 with the cup 344 to maneuver food items (not shown) in the interior of the first pan 102, including collecting and dispensing the food items, and is capable of reaching the interior of the second pan 120 with the cup 344 to maneuver food items (not shown) in the interior of the second pan 120, including collecting and dispensing the food items.

As depicted in FIGS. 14-16, the cup 344 includes a cup body 346 that defines an interior configured for containing food items when the cup 344 is held in an upright position. As depicted in FIG. 17, the cup 344 includes a grip 348 having a knob 350, a grip body 352, and a stop 354.

The knob 350 is disposed on a proximal end 360 of the grip body 352 and the stop 354 is disposed on a distal end 362 of the grip body 352 such that the grip body 352 is interposed between and separates the knob 350 and the stop 354 on the grip 348 along a longitudinal direction of the cup 344. The grip body 352 is a stem of the cup 344, where the grip body 352 has a circular shape extended in the longitudinal direction of the cup 344, the circular shape of the grip body 352 being complementary with the rounded portion 250 of the first inner surface 244 of the first finger 210 and the rounded portion 272 of the second inner surface 270 of the second finger 212 such that the grip body 352 is configured for being gripped by the first finger 210 and the second finger 212. In this manner, the robot arm 134 is capable of holding the cup 344 at the grip body 352 with the end effector 204, between the knob 350 and the stop 354 in the longitudinal direction of the cup 344.

The knob 350 is shaped as a spheroid which extends perpendicular to the longitudinal direction of the cup 344 beyond the grip body 352 such that the knob 350 obstructs the first finger 210 and the second finger 212 from moving away from the cup body 346 along the longitudinal direction of the cup 344 when the end effector 204 is holding the cup 344. The stop 354 is a circular plate which extends perpendicular to the longitudinal direction of the cup 344 beyond the grip body 352 such that the stop 354 obstructs the first finger 210 and the second finger 212 from moving toward the cup body 346 along the longitudinal direction of the cup 344 when the end effector 204 is holding the cup 344. As such, the rounded portion 250 of the first inner surface 244 and the rounded portion 272 of the second inner surface 270 are locked between the knob 350 and the stop 354 with respect to the longitudinal direction of the cup 344 when the end effector 204 is holding the grip 348.

Because the knob 350 and the stop 354 feature circular profiles taken from the longitudinal direction of the cup 344, the knob 350 and the stop 354 are configured for obstructing movement of the first finger 210 and the second finger 212 from any radial angle of the grip body 352 at which the first finger 210 and the second finger 212 are configured to hold the grip body 352. While the depicted knob 350 is formed with a spheroid shape, the knob 350 may be otherwise formed to extend beyond the grip body 352 in a direction perpendicular to the longitudinal direction of the cup 344 for similarly obstructing the first finger 210 and the second finger 212 without departing from the scope of the present disclosure. Also, while the depicted stop 354 is a circular disk, the stop 354 may be otherwise formed to extend beyond the grip body 352 in a direction perpendicular to the longitudinal direction of the cup 344 for similarly obstructing the first finger 210 and the second finger 212 without departing from the scope of the present disclosure.

Because the rounded portion 250 of the first inner surface 244 and the rounded portion 272 of the second inner surface 270 are complementary with the grip body 352, which has a circular shape extended in the longitudinal direction of the cup 344, the first finger 210 and the second finger 212 are obstructed from moving in a direction perpendicular to the longitudinal direction of the cup 344 relative to the grip body 352 when the end effector 204 is holding the cup 344. Also, the first finger 210 and the second finger 212 are obstructed from rotating in a direction offset from the longitudinal direction of the cup 344 at the grip body 352 when the end effector 204 is holding the cup 344. Further, the grip body 352 is configured for being held by the end effector 204 such that the first finger 210 and the second finger 212 extend in a direction perpendicular to the longitudinal direction of the cup 344. In an embodiment where the grip body 352 is formed from a shape extended in the longitudinal direction of the cup 344 that deviates from the circular shape, and the rounded portion 250 portion of the first inner surface 244 and the rounded portion 272 of the second inner surface 270 are complementary to the non-circular shape, the first finger 210 and the second finger 212 are further obstructed from rotating in the longitudinal direction of the cup 344 at the grip body 352.

As depicted in FIG. 17, the grip 348 of the cup 344 is configured for being held by the end effector 204 such that the first finger 210 and the second finger 212 extend in a direction perpendicular to the grip body 352 which extends in the longitudinal direction of the cup 344, while as depicted in FIG. 3, the grip 144 of the spatula 140 is configured for being held by the end effector 204 such that the first finger 210 and the second finger 212 extend in a direction parallel with the grip 144, which extends in the longitudinal direction of the spatula 140. Notably, the cup body 346 may be alternatively formed as a spatula, a lid, a fork, a spoon, a knife, a whisk, a strainer, a grater, or other cooking utensil for use at the kitchen station 100 without departing from the scope of the present disclosure, and further may be alternatively formed as a pan, a pot, a wok, a sauce pan, a sheet pan, a cooking sheet, a baking rack, or a similar cooking hardware otherwise configured for being maneuvered by the robot arm 134 through the grip 348 for use at the kitchen station 100 without departing from the scope of the present disclosure. In this manner, cooking utensils adapted for use with the end effector such as the spatula 140 and the cup 344 may include gripping features adapted to the rounded portion 250 of the first inner surface 244, the flat portion 252 of the first inner surface 244, the rounded portion 272 of the second inner surface 270, and the flat portion 274 of the second inner surface 270 for being held with a particular orientation relative to the end effector 204. Notably, cooking utensils adapted for use with the end effector 204 such as the spatula 140 and the cup 344 may additionally or alternatively include gripping features adapted to the end effector 204 for being held in an orientation offset from the extended direction of the first finger 210 and the second finger 212 as in the spatula 140, and offset from a direction perpendicular to the extended direction of the first finger 210 and the second finger 212 as in the cup 344 without departing from the scope of the present disclosure.

A method of engaging the end effector 204 with one of the spatula 140 and the cup 344 includes fixing the grip 144, 348 with a body included in the spatula 140 and the cup 344 and configured for maneuvering food items such that the grip 144, 348 extends from the body in the longitudinal direction of the spatula 140 and the cup 344, where the grip 144, 348 includes the grip body 152, 352, the knob 150, 350 disposed on the proximal end 160, 360 of the grip body 152, 352, and the stop 154, 354 disposed on the distal end 162, 362 of the grip body 152, 352 such that the grip body 152, 352 is interposed between and separates the knob 150, 350 and the stop 154, 354 in the longitudinal direction of the spatula 140 and the cup 344, the knob 150, 350 and the stop 154, 354 extending beyond the grip body 152, 352 in the first lateral direction 156 of the spatula 140 and the cup 344. The method also includes mounting the first finger 210 on the hand 224 included in the end effector 204 such that the first finger 210 is configured for being actuated with respect to the hand 224 in the first lateral direction 156 of the spatula 140 and the cup 344. The method also includes actuating the first finger 210 with respect to the hand 224 in the first lateral direction 156 of the spatula 140, the cup 344 to engage the first finger 210 with the grip 144, 348 in the first lateral direction 156 of the spatula 140 and the cup 344.

In the method, the first inclined surface 276 of the first finger 210 is inclined toward the grip body 152, 352 in the first lateral direction 156 of the spatula 140 and the cup 344, and toward the stop 154, 354 in the longitudinal direction of the spatula 140 and the cup 344, and engages the knob 150, 350 in the longitudinal direction and the first lateral direction 156 of the spatula 140 and the cup 344. In the method, the first longitudinal end surface of the first finger 210 extends from the first inclined surface 276 of the first finger 210 and toward the stop 154, 354 in the longitudinal direction of the spatula 140 and the cup 344 engages the grip 144, 348 between the knob 150, 350 and the stop 154, 354 in the longitudinal direction of the spatula 140 and the cup 344.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the present disclosure.

1. A cooking system comprising:
an end effector and a cooking utensil configured for being maneuvered about a kitchen station through the end effector,
wherein the cooking utensil includes:
a body configured for maneuvering food items; and
a grip fixed with the body and extended from the body in a longitudinal direction of the cooking utensil, the grip comprising:
a grip body;
a knob disposed on a proximal end of the grip body; and
a stop disposed on a distal end of the grip body such that the grip body is interposed between and separates the knob and the stop in the longitudinal direction of the cooking utensil,
wherein the knob and the stop extend beyond the grip body in a first lateral direction of the cooking utensil perpendicular to the longitudinal direction of the cooking utensil, and the knob forms a first inclined surface that is inclined outward from the grip body in the first lateral direction of the cooking utensil, and away from the stop in the longitudinal direction of the cooking utensil,
wherein the end effector includes:
a hand; and
a first finger mounted on the hand, and configured for being actuated with respect to the hand and engaging the grip in the first lateral direction of the cooking utensil, wherein the first finger includes:
a first inclined surface configured for engaging and extending along the first inclined surface of the knob in the longitudinal direction and the first lateral direction of the cooking utensil; and
a first longitudinal end surface extended from the first inclined surface of the first finger in the longitudinal direction of the cooking utensil, and configured for extending along the grip body and engaging the stop in the longitudinal direction of the cooking utensil.

2. The cooking system of claim 1, wherein the first longitudinal end surface of the first finger extends along the grip body in the longitudinal direction of the cooking utensil from the knob to the stop, and engages each of the knob and the stop in the longitudinal direction of the cooking utensil.

3. The cooking system of claim 1, wherein the first longitudinal end surface of the first finger is planar and extends in the longitudinal direction and a second lateral direction perpendicular to the longitudinal direction and the first lateral direction of the cooking utensil.

4. The cooking system of claim 3, wherein the grip body forms a planar surface that extends in the longitudinal direction and the second lateral direction of the cooking utensil, wherein the planar surface of the grip body is configured for engaging the first longitudinal end surface of the first finger in the first lateral direction of the cooking utensil.

5. The cooking system of claim 1, wherein the knob forms a second inclined surface that is inclined toward the grip body in the first lateral direction of the cooking utensil, and away from the stop in the longitudinal direction of the cooking utensil, and
wherein the first finger forms a second inclined surface configured for engaging and extending along the second inclined surface of the knob in the longitudinal direction and the first lateral direction of the cooking utensil.

6. The cooking system of claim 5, wherein the first inclined surface and the second inclined surface of the knob are rounded toward the grip body in the first lateral direction of the cooking utensil, and
wherein the first inclined surface and the second inclined surface of the first finger are rounded toward the grip body in the first lateral direction of the cooking utensil so as to extend along the first inclined surface and the second inclined surface of the knob in the longitudinal direction and the first lateral direction of the cooking utensil.

7. The cooking system of claim 5, wherein the first inclined surface and the second inclined surface of the knob extend continuously with each other in the longitudinal direction of the cooking utensil.

8. The cooking system of claim 5, wherein the first inclined surface and the second inclined surface of the knob are formed on opposite sides of the knob in the longitudinal direction of the cooking utensil, and
wherein the first inclined surface and the second inclined surface of the first finger are respectively configured for engaging the first inclined surface and the second inclined surface of the knob at opposite sides of the knob in the longitudinal direction of the cooking utensil.

9. The cooking system of claim 1, wherein the stop includes a first flange extended beyond the grip body in the first lateral direction of the cooking utensil, and extended along the grip body in a second lateral direction of the cooking utensil perpendicular to the longitudinal direction and the first lateral direction of the cooking utensil, and
wherein the first longitudinal end surface is configured to engage the stop in the longitudinal direction of the cooking utensil, along the grip body in the second lateral direction of the cooking utensil.

10. The cooking system of claim 9, wherein the first flange forms a planar surface extended in the first lateral direction and the second lateral direction of the cooking utensil such that the planar surface of the first flange engages the first longitudinal end surface in the longitudinal direction of the cooking utensil, along the second lateral direction of the cooking utensil.

11. The cooking system of claim 1, wherein the knob, the grip body, and the stop form a lateral surface of the grip facing the first lateral direction of the cooking utensil and configured for engaging the first finger, wherein the lateral surface of the grip extends straight in a second lateral direction of the cooking utensil perpendicular to the longitudinal direction and the first lateral direction of the cooking utensil, and
wherein the first inclined surface and the first longitudinal end surface of the first finger extend straight in the second lateral direction of the cooking utensil for engaging the lateral surface of the grip in the first lateral direction of the cooking utensil.

12. The cooking system of claim 1, wherein the grip body extends in the longitudinal direction of the cooking utensil to the knob, forming a first knob incongruity in the grip directly between the first inclined surface of the knob and the grip body,
wherein the grip body extends in the longitudinal direction of the cooking utensil to the stop, forming a second knob incongruity in the grip directly between the stop and the grip body,
wherein the first longitudinal end surface of the first finger extends to the first inclined surface of the first finger in the longitudinal direction of the cooking utensil, forming a first finger incongruity in the first finger directly between the first inclined surface of the knob and the first longitudinal end surface, the first finger incongruity at the first inclined surface being configured for engaging the first knob incongruity, and
wherein the first longitudinal end surface extends in the longitudinal direction of the cooking utensil and forms a second finger incongruity in the first finger, the second finger incongruity being configured for engaging the second knob incongruity such that the first finger is interlocked with the grip in the longitudinal direction of the cooking utensil.

13. The cooking system of claim 12, wherein the first knob incongruity and the second knob incongruity formed in the grip are corners which extend to opposite sides of the grip in a second lateral direction of the cooking utensil perpendicular to the longitudinal direction and the first lateral direction of the cooking utensil, and the first finger incongruity and the second finger incongruity are corners which extend to opposite sides of the first finger in the second lateral direction of the cooking utensil.

14. The cooking system of claim 1,
wherein the cooking utensil includes a shaft extended from the grip in the longitudinal direction of the cooking utensil, and fixed with the body such that the shaft is interposed between and separates the grip and the shaft in the longitudinal direction of the cooking utensil, and
wherein the shaft and the first inclined surface of the first finger are rounded with respect to the longitudinal direction of the cooking utensil such that the first inclined surface of the first finger is configured to extend around and engage the shaft in the first lateral direction of the cooking utensil.

15. The cooking system of claim 1, wherein the first longitudinal end surface is configured to directly engage the stop, the grip body, and the first inclined surface of the grip, and the first inclined surface of the first finger is configured to directly engage the first inclined surface of the knob.

16. The cooking system of claim 1, wherein the end effector further comprises a second finger mounted on a side of the hand opposite the first finger in the first lateral direction of the cooking utensil, the second finger configured for being actuated with respect to the hand and engaging a side of the grip opposite the first finger in the first lateral direction of the cooking utensil.

17. The cooking system of claim 16, wherein the knob forms a third inclined surface on a side of the grip opposite the first inclined surface in the first lateral direction of the cooking utensil, the third inclined surface being inclined outward from the grip body in the first lateral direction of the cooking utensil, and away from the stop in the longitudinal direction of the cooking utensil,
wherein the second finger forms a third inclined surface configured for engaging and extending along the third inclined surface of the knob in the longitudinal direction and the first lateral direction of the cooking utensil; and
wherein the second finger forms a second longitudinal end surface extended from the third inclined surface of the first finger in the longitudinal direction of the cooking utensil, and configured for extending along the grip body and engaging the stop in the longitudinal direction of the cooking utensil.

18. The cooking system of claim 1, further comprising an intermediate holder mounted on the kitchen station and configured for supporting the cooking utensil, the intermediate holder including a first projection and a second projection extended outward from the kitchen station in a first lateral direction of the kitchen station, and spaced apart in a second lateral direction of the kitchen station to define a gap therebetween,
wherein the cooking utensil includes a utensil mount fixed with the grip, the utensil mount being interposed between the grip and the body in the longitudinal direction of the cooking utensil, the utensil mount having a width greater than the gap defined between the first projection and the second projection in the second lateral direction of the kitchen station such that the intermediate holder is configured to support the cooking utensil at the utensil mount between the first projection and the second projection in the second lateral direction of the kitchen station.

19. The cooking system of claim 18, wherein the cooking utensil includes a shaft extended in the longitudinal direction of the cooking utensil, wherein the utensil mount is fixed to a proximal end portion of the shaft and the body is fixed with a distal end portion of the shaft such that the shaft is interposed between and separates the body and the grip in the longitudinal direction of the cooking utensil, the shaft having a width smaller than the gap defined between the first projection and the second projection such that the gap is configured to receive the shaft in the first lateral direction of the kitchen station and support the cooking utensil at the utensil mount.

20. A method of engaging an end effector with a cooking utensil, the method comprising:
fixing a grip with a body included in the cooking utensil and configured for maneuvering food items such that the grip extends from the body in a longitudinal direction of the cooking utensil, wherein the grip includes a grip body, a knob disposed on a proximal end of the grip body, and a stop disposed on a distal end of the grip body such that the grip body is interposed between and separates the knob and the stop in the longitudinal direction of the cooking utensil, the knob and the stop extending beyond the grip body in a first lateral direction of the cooking utensil perpendicular to the longitudinal direction of the cooking utensil;
mounting a first finger on a hand included in the end effector such that the first finger is configured for being actuated with respect to the hand in a first lateral direction of the cooking utensil perpendicular to the longitudinal direction of the cooking utensil, and
actuating the first finger with respect to the hand in the first lateral direction of the cooking utensil to engage the first finger with the grip in the first lateral direction of the cooking utensil,
wherein a first inclined surface of the first finger that is inclined toward the grip body in the first lateral direction of the cooking utensil, and toward the stop in the longitudinal direction of the cooking utensil, engages the knob in the longitudinal direction and the first lateral direction of the cooking utensil, and
wherein a first longitudinal end surface of the first finger that extends from the first inclined surface of the first finger and toward the stop in the longitudinal direction of the cooking utensil engages the grip between the knob and the stop in the longitudinal direction of the cooking utensil.
